(19) United States
(12) Patent Application Publication
(10) Pub. No.: US 2023/0264372 A1
(43) Pub. Date: Aug. 24, 2023

(54) HINGED UTILITY KNIFE

(71) Applicant: Zeluga, Inc., Carrollton, TX (US)

(72) Inventor: Sumesh Bhagat, Carrollton, TX (US)

(21) Appl. No.: 18/111,725

(22) Filed: Feb. 20, 2023

Related U.S. Application Data
(60) Provisional application No. 63/311,851, filed on Feb. 18, 2022.

(51) Int. Cl. B26B 5/00

(52) U.S. Cl. CPC B26B 5/006

(57) ABSTRACT

A utility knife constructed of a lower shell (102), an upper shell (104), a retaining knob (106) and a hinge pin (108). The hinge pin (110) provides a high-strength connection between lower shell (102) and upper shell (104). Retaining magnets (110) and (112) retain steel utility blades in place when shells (102) and (104) are separated from one another. According to one embodiment, the retaining magnets (110) and (112) are permanent magnets made of an alloy of neodymium, iron and boron.

### FIELD OF THE DISCLOSURE

The present disclosure generally relates to a hinged utility knife for use in building construction and related industries.

### SUMMARY OF THE PRESENT DISCLOSURE

The teachings of the present disclosure relate to an improved hinged utility knife having features designed to increase the durability and longevity of the tool without adding significantly to the cost thereof.

### BRIEF DESCRIPTION OF THE DRAWINGS

The foregoing disclosure will be best understood and advantages thereof made most clearly apparent when consideration is given to the following detailed description in combination with the drawing figures presented. The detailed description makes reference to the following drawing figures:

FIG. 1A is a bottom view of the utility knife of the present disclosure.

FIG. 1B is a bottom-side view of the utility knife of the present disclosure.

FIG. 1C is a first side view of the utility knife of the present disclosure.

FIG. 1D is a top view of the utility knife of the present disclosure.

FIG. 1E is a second side view of the utility knife of the present disclosure.

FIG. 1F is a first end view of the utility knife of the present disclosure.

FIG. 1G is a second end view of the utility knife of the present disclosure.

FIG. 1H is a section view of the utility knife of the present disclosure.

FIG. 2 is an exploded view of the utility knife of the present disclosure.

FIG. 3A is a bottom view of the bottom shell of the utility knife of the present disclosure.

FIG. 3B is an internal side view of the bottom shell of the utility knife of the present disclosure.

FIG. 3C is a top view of the bottom shell of the utility knife of the present disclosure.

FIG. 3D is an external side view of the bottom shell of the utility knife of the present disclosure.

FIG. 3E is a first end view of the bottom shell of the utility knife of the present disclosure.

FIG. 3F is a second end view of the bottom shell of the utility knife of the present disclosure.

FIG. 4A is a bottom view of the top shell of the utility knife of the present disclosure.

FIG. 4B is an external side view of the top shell of the utility knife of the present disclosure.

FIG. 4C is a top view of the top shell of the utility knife of the present disclosure.

FIG. 4D is an internal side view of the top shell of the utility knife of the present disclosure.

FIG. 4E is a first end view of the top shell of the utility knife of the present disclosure.

FIG. 4F is a second end view of the top shell of the utility knife of the present disclosure.

FIG. 5A is a top view of the retaining knob of the utility knife of the present disclosure.

FIG. 5B is an oblique view of the retaining knob of the utility knife of the present disclosure.

FIG. 5C is a side view of the retaining knob of the utility knife of the present disclosure.

FIG. 5D is a bottom view of the retaining knob of the utility knife of the present disclosure.

### DETAILED DESCRIPTION OF THE DRAWING FIGURES

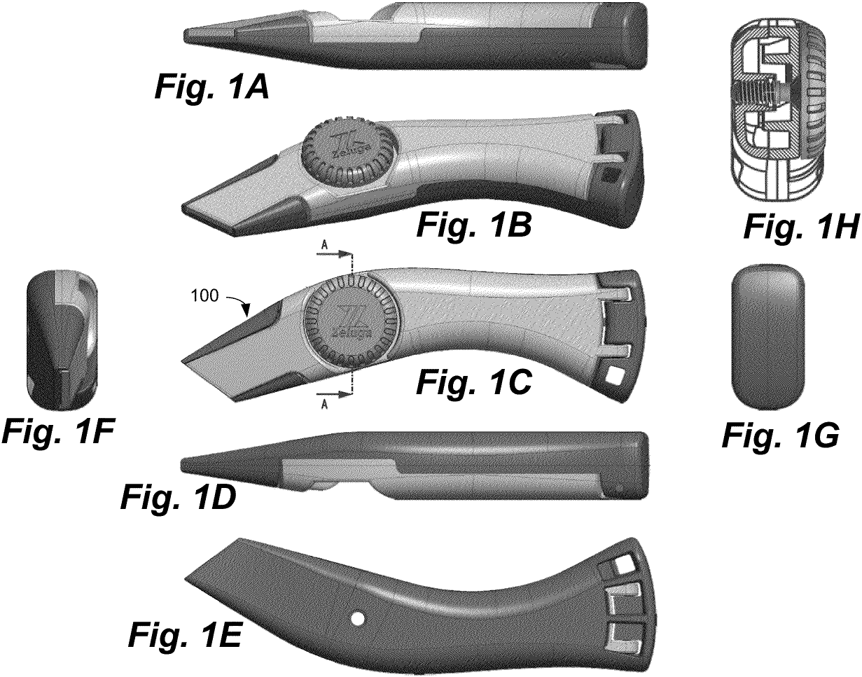

FIGS. 1A-1H show bottom, oblique, first side, top, second side, first end, second end and section views of a utility knife 100 according to the present disclosure.

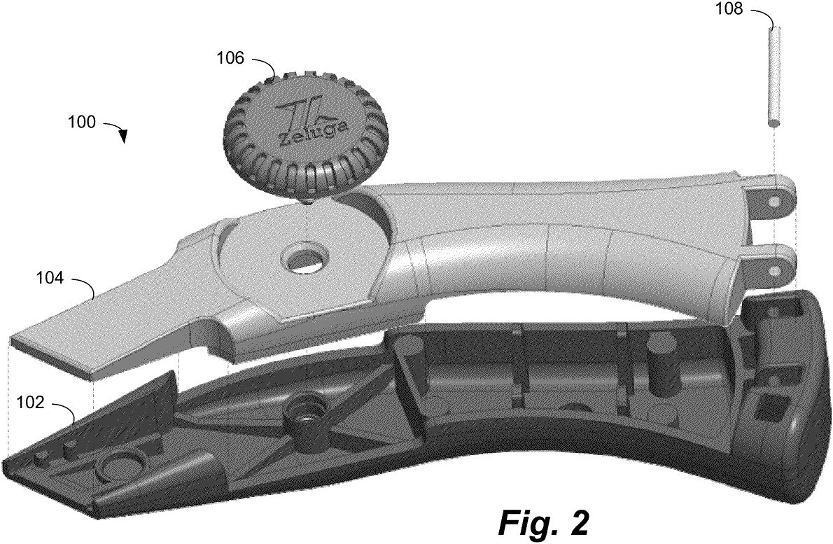

FIG. 2 is an exploded view of the utility knife 100 shown in FIGS. 1A-1H. Utility knife 100 is constructed of a lower shell 102, an upper shell 104, a retaining knob 106 and a hinge pin 108. The use of hinge pin 110 provides a high-strength connection between lower shell 102 and upper shell 104. In durability testing, the connection has been demonstrated to withstand repeated drops from over 3 meters high without failure. Certain of the components shown in FIG. 2 are shown in additional detail in the following figures.

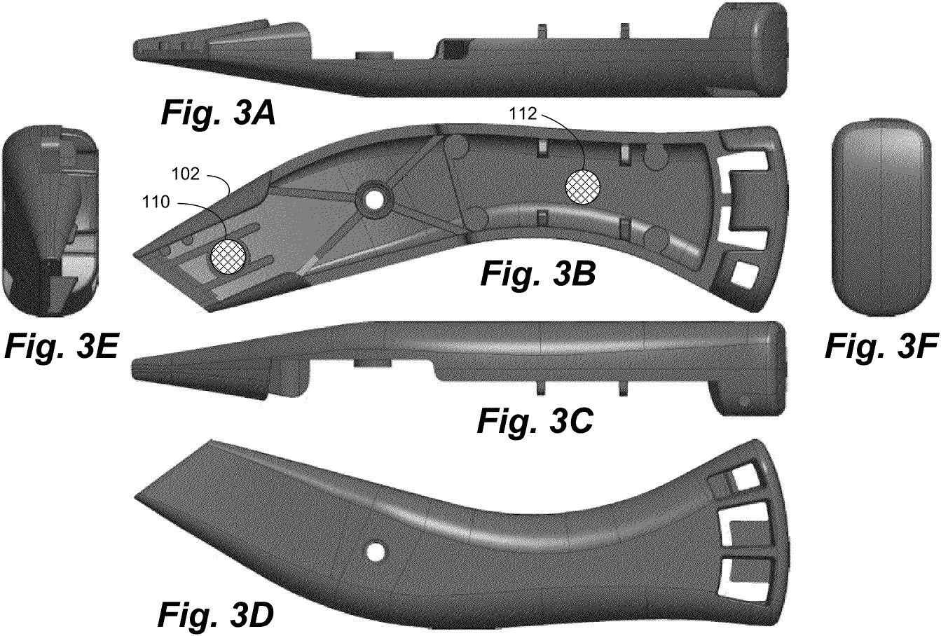

FIGS. 3A-3F show bottom, internal side, top, external side, first end and second end views of lower shell 102 of utility knife 100, respectively. The internal structural details of lower shell 102 can be seen in FIG. 3B. Of particular interest are retaining magnets 110 and 112, which retain steel utility blades in place when shells 102 and 104 are separated from one another. According to one embodiment, retaining magnets 110 and 112 are permanent magnets made of an alloy of neodymium, iron and boron. Such magnets are commonly known as “N35 magnets,” “neodymium magnets,” “NdFeB magnets,” “Neo magnets” and “NIB magnets.” Alternate types of magnets may be employed for the same purpose. Retaining magnets 110 and 112 may be secured to lower shell 102 using any suitable adhesive. According to one embodiment, retaining magnets 110 and 112 are secured to lower shell by a high-strength anaerobic adhesive.

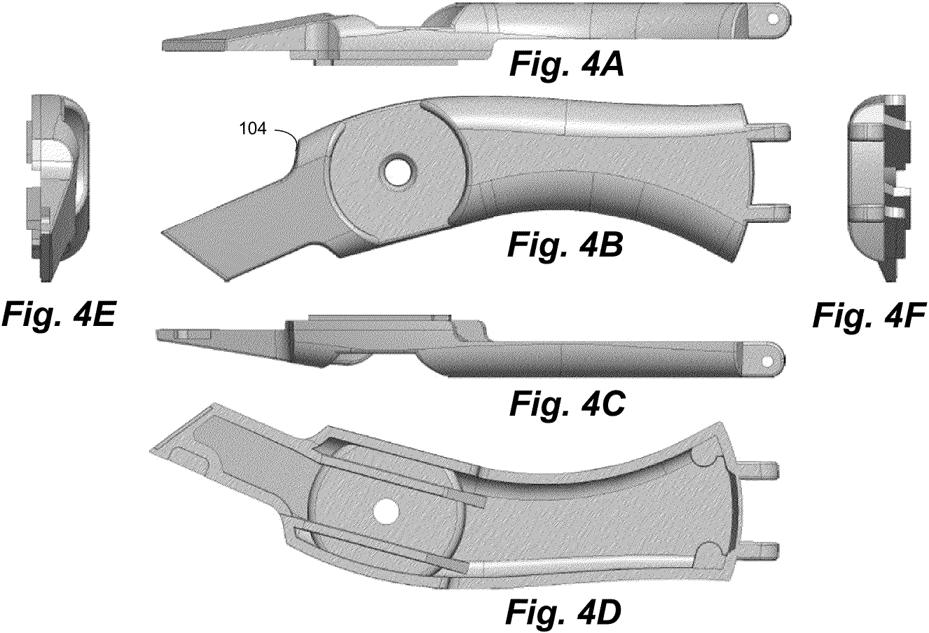

FIGS. 4A-4F show bottom, external side, top, internal side, first end and second end views of upper shell 104 of utility knife 100, respectively.

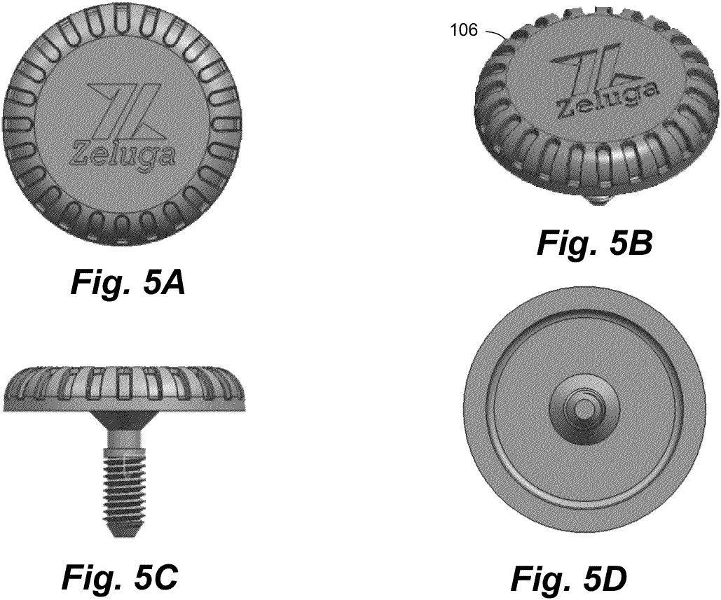

FIGS. 5A-5D show top, oblique, side and bottom views of retaining knob 106 of utility knife 100, respectively.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C .... and N, the text should be interpreted as requiring only one element from the group, not A plus N, or B plus N, etc.

1. A utility knife comprising:
an upper shell;
a lower shell;
a retaining knob; and
a hinge pin.
